(19) United States
(12) Patent Application Publication
(10) Pub. No.: US 2024/0276450 A1
(43) Pub. Date: Aug. 15, 2024

(54) PAGING RECEPTION WITH LOW POWER SIGNALS

(71) Applicant: Samsung Electronics Co., Ltd., Suwon-si (KR)

(72) Inventors: Kyeongin Jeong, Allen, TX (US); Hongbo Si, Allen, TX (US); Shiyang Leng, Allen, TX (US)

(21) Appl. No.: 18/434,562

(22) Filed: Feb. 6, 2024

Related U.S. Application Data
(60) Provisional application No. 63/445,583, filed on Feb. 14, 2023.

(51) Int. Cl. H04W 68/02; H04W 52/02

(52) U.S. Cl. CPC H04W 68/02; H04W 52/0229

(57) ABSTRACT

Methods and apparatuses for a paging reception with low power signals in a wireless communication system. A method of a UE comprises: receiving, from a base station (BS), system information (SI); identifying, based on the SI, time occasions to monitor a low power-wake-up signal (LP-WUS) from a plurality of LP-WUSs; monitoring, based on the time occasions, the LP-WUS associated with a serving cell; determining whether the LP-WUS is detected in the time occasions; and monitoring, based on the determination that the LP-WUS is detected, at least one of a paging early indicator (PEI) and a paging message.

### CROSS-REFERENCE TO RELATED APPLICATIONS AND CLAIM OF PRIORITY

The present application claims priority to U.S. Provisional Patent Application No. 63/445,583, filed on Feb. 14, 2023. The contents of the above-identified patent documents are incorporated herein by reference.

### TECHNICAL FIELD

The present disclosure relates generally to wireless communication systems and, more specifically, the present disclosure relates to paging reception with low power signals in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a paging reception with low power signals in a wireless communication system.

In one embodiment, a user equipment (UE) in a wireless communication system is provided. The UE comprises a transceiver configured to receive, from a base station (BS), system information (SI). The UE further comprises a processor operably coupled to the transceiver, the processor configured to: identify, based on the SI, time occasions to monitor a low power-wake-up signal (LP-WUS) from a plurality of LP-WUSs, monitor, based on the time occasions, the LP-WUS associated with a serving cell, determine whether the LP-WUS is detected in the time occasions, and monitor, based on the determination that the LP-WUS is detected, at least one of a paging early indicator (PEI) and a paging message.

In another embodiment, a method of a UE in a wireless communication system is provided. The method comprises: receiving, from a BS, SI; identifying, based on the SI, time occasions to monitor a LP-WUS from a plurality of LP-WUSs; monitoring, based on the time occasions, the LP-WUS associated with a serving cell; determining whether the LP-WUS is detected in the time occasions; and monitoring, based on the determination that the LP-WUS is detected, at least one of a PEI and a paging message.

In yet another embodiment, a BS in a wireless communication system is provided. The BS comprises a processor configured to generate SI including time occasions for LP-WUS. The BS further comprise a transceiver operably coupled to the transceiver, the transceiver configured to transmit, to a UE, the SI, wherein: the LP-WUS associated with a serving cell is monitored from a plurality of LP-WUSs based on the time occasions, and at least one of a PEI and a paging message is monitored based on a detectability of the LP-WUS.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according

to this disclosure;

FIG. 6 illustrates another flowchart of a method for a paging reception with LP-WUS according to embodiments of the present disclosure;

FIG. 7 illustrates another flowchart of a method for a paging reception with LP-WUS according to embodiments of the present disclosure;

FIG. 8 illustrates yet another flowchart of a method for a paging reception with LP-WUS according to embodiments of the present disclosure; and

FIG. 9 illustrates a flowchart of a UE method for a paging reception with low power signals according to embodiments of the present disclosure.

### DETAILED DESCRIPTION

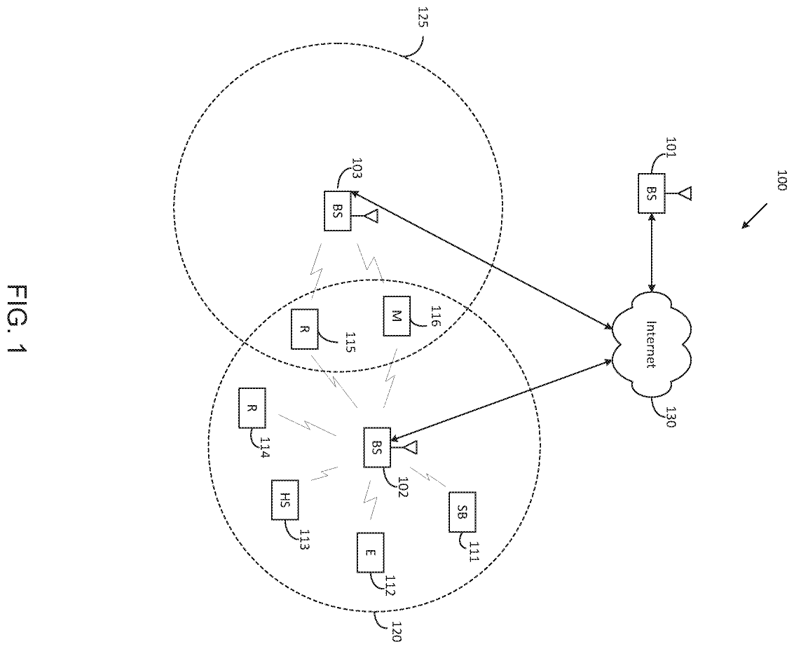

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v17.4.0, “NR; Physical channels and modulation”; 3GPP TS 38.212 v17.4.0, “NR; Multiplexing and channel coding”; 3GPP TS 38.213 v17.4.0, “NR; Physical Layer Procedures for Control”; 3GPP TS 38.214 v17.4.0, “NR; Physical Layer Procedures for data”; 3GPP TS 38.304 v17.3.0, “NR; User Equipment (UE) procedures in idle mode and RRC inactive state”; 3GPP TS 38.331 v17.3.0, “NR; Radio Resource Control (RRC) protocol specification”; 3GPP TS 23.122 v17.9.0, “NAS functions related to Mobile Station (MS) in RRC_IDLE state”; 3GPP TS 38.133 v17.8.0, “NR: Requirements for Support of Radio Resource Management”; and 3GPP TS 23.003 v17.8.0, “Numbering, addressing and identification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for paging reception with low power signals in a wireless communication system. In certain embodiments, and one or more of the gNBs 101-103 includes circuitry, programing, or a combination thereof, to support the UE in paging reception with low power signals in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

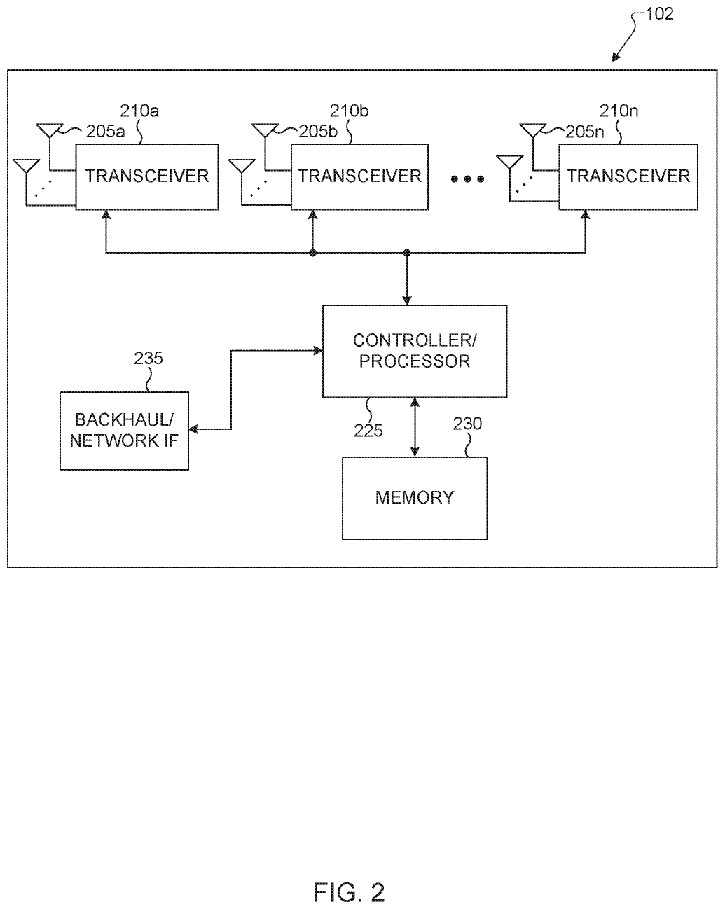

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes for supporting the UE in paging reception with low power signals in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

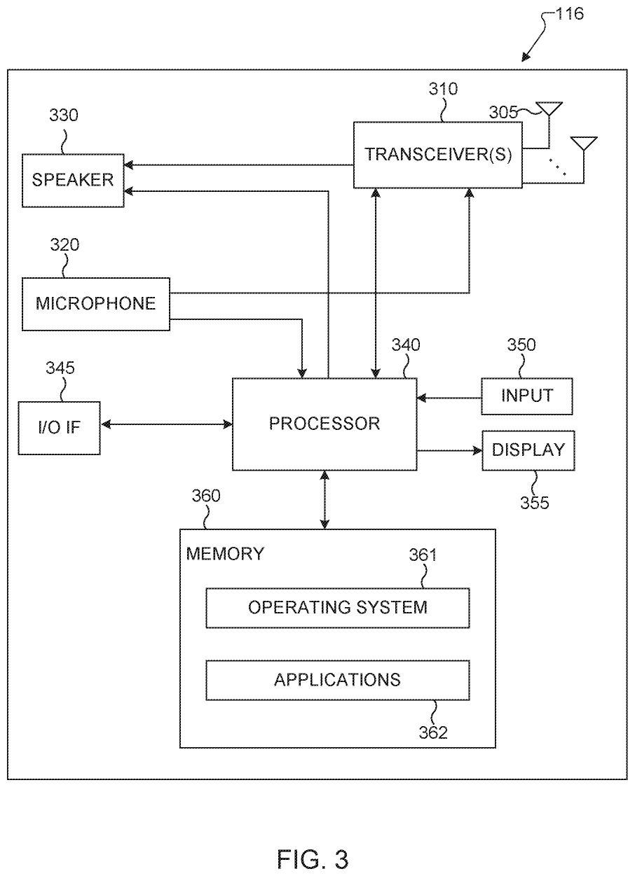

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for paging reception with low power signals in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

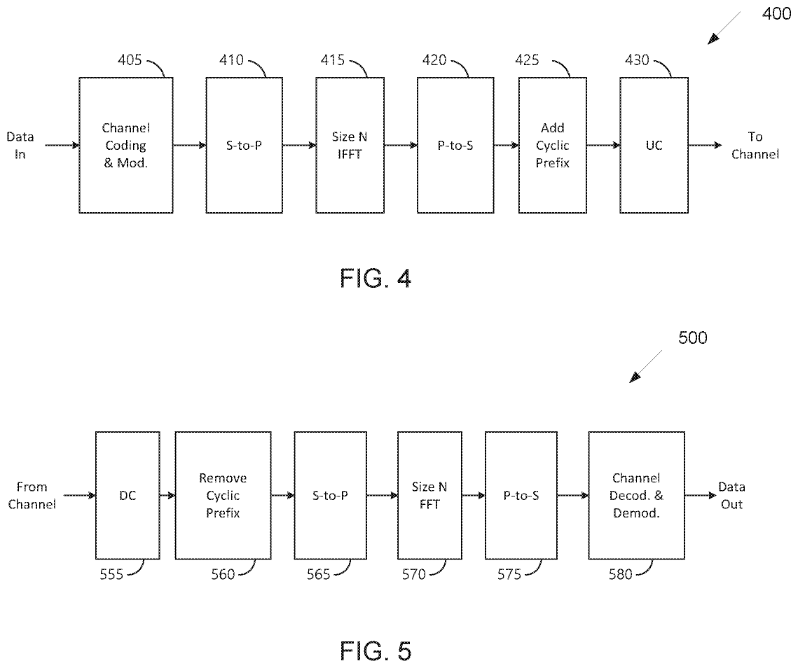

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the UE in paging reception with low power signals in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In 3GPP (3rd Generation Partnership Project) wireless standards, NR (New RAT: Radio Access Technology) has been specified as 5G wireless communication. One of NR features is UE power saving. NR supported discontinuous reception (DRX) for a UE in either RRC idle/inactive mode/state or RRC connected state, such that the UE could stop receiving signals or channels during DRX inactive time periods within a DRX cycle and save power consumption. In Rel-16, an enhancement towards DRX for RRC connected state (C-DRX) was introduced, wherein a new DCI format was used to help the UE to skip a DRX on-duration within a C-DRX cycle such that further power saving gain could be achieved. In Rel-17, enhancement towards DRX for RRC idle/inactive mode/state was introduced, wherein a paging early indication (PEI) was used for a UE to skip monitoring paging occasions such that extra power saving gain could be achieved. However, the UE still needs to frequently wake up to monitor a new DCI format where includes PEI, such that the radio of the UE cannot be fully turned off for a long time duration. To avoid such situation and to acquire further power saving gain, an additional receiver radio is considered, wherein the additional receiver radio can be used for monitoring a particular set of signals with very low power consumption (hereafter the particular set of signals is also called as LP-WUS, Lower-Power Wake-Up Signal), and the main receiver radio can be turned off or operating with a very lower power for a long time duration. That particular set of signals may also include a kind of compact synchronization signal and/or measurement reference signal, so the particular set of signals can be also used for measurement purpose.

The present disclosure focuses on paging reception with the lower power signals that could be received by the additional receiver radio.

A paging reception for RRC idle/inactive mode/state is illustrated as shown in TABLE 1.

TABLE 1
A paging reception for RRC idle/inactive mode/state

Paging
Discontinuous Reception for paging
The UE may use Discontinuous Reception (DRX) in RRC_IDLE and RRC_INACTIVE state
in order to reduce power consumption. The UE monitors one paging occasion (PO) per DRX
cycle. A PO is a set of PDCCH monitoring occasions and can include multiple time slots (e.g.,
subframe or OFDM symbol) where paging DCI can be sent. One Paging Frame (PF) is one
Radio Frame and may contain one or multiple PO(s) or starting point of a PO. A L2 U2N
Relay UE monitors the paging occasions of its PC5-RRC connected L2 U2N Remote UEs. In
this case, the DRX cycle and UE ID mentioned in this clause refer to those of the L2 U2N
Remote UE.
In multi-beam operations, the UE assumes that the same paging message and the same Short
Message are repeated in all transmitted beams and thus the selection of the beam(s) for the
reception of the paging message and Short Message is up to UE implementation. The paging
message is same for both RAN initiated paging and CN initiated paging.
The UE initiates RRC Connection Resume procedure upon receiving RAN initiated paging. If
the UE receives a CN initiated paging in RRC_INACTIVE state, the UE moves to RRC_IDLE
and informs NAS. However, if a L2 U2N Relay UE in RRC_INACTIVE state receives a CN
initiated paging for a L2 U2N Remote UE, the L2 U2N Relay UE does not move to
RRC_IDLE state.

| | |
|---|---|
| NOTE 0a: | The L2 U2N Remote UE does not need to monitor the PO in order to receive |

the paging message.

| | |
|---|---|
| NOTE 0b: | While the SDT procedure is ongoing in RRC_INACTIVE state, the UE |

monitors the PO in order to receive only the Short Message as specified in 3GPP
standard specification.

The PF and PO for paging are determined by the following formulae:
SFN for the PF is determined by:

(SFN + PF_offset) mod T = (T div N)*(UE_ID mod N)

Index (i_s), indicating the index of the PO is determined by:

i_s = floor (UE_ID/N) mod Ns

The PDCCH monitoring occasions for paging are determined according to pagingSearchSpace
as specified in 3GPP standard specification and firstPDCCH-MonitoringOccasionOfPO and
nrofPDCCH-MonitoringOccasionPerSSB-InPO if configured as specified in 3GPP standard
specification. When SearchSpaceId = 0 is configured for pagingSearchSpace, the PDCCH
monitoring occasions for paging are same as for RMSI as defined in 3GPP standard
specification.
When SearchSpaceId = 0 is configured for pagingSearchSpace, Ns is either 1 or 2. For Ns = 1,
there is only one PO which starts from the first PDCCH monitoring occasion for paging in the
PF. For Ns = 2, PO is either in the first half frame (i_s = 0) or the second half frame (i_s = 1)
of the PF.
When SearchSpaceId other than 0 is configured for pagingSearchSpace, the UE monitors the
(i_s + 1)^{th} PO. A PO is a set of “S*X” consecutive PDCCH monitoring occasions where “S” is
the number of actual transmitted SSBs determined according to ssb-PositionsInBurst in SIB1
and X is the nrofPDCCH-MonitoringOccasionPerSSB-InPO if configured or is equal to 1
otherwise. The [x*S+K]^{th} PDCCH monitoring occasion for paging in the PO corresponds to
the K^{th} transmitted SSB, where x=0,1, ...,X−1, K=1,2, ...,S. The PDCCH monitoring
occasions for paging which do not overlap with UL symbols (determined according to tdd-UL-
DL-ConfigurationCommon) are sequentially numbered from zero starting from the first
PDCCH monitoring occasion for paging in the PF. When firstPDCCH-
MonitoringOccasionOfPO is present, the starting PDCCH monitoring occasion number of (i_s
+ 1)^{th} PO is the (i_s + 1)^{th} value of the firstPDCCH-MonitoringOccasionOfPO parameter;
otherwise, it is equal to i_s * S*X. If X > 1, when the UE detects a PDCCH transmission
addressed to P-RNTI within its PO, the UE is not required to monitor the subsequent PDCCH
monitoring occasions for this PO.

| | |
|---|---|
| NOTE 1: | A PO associated with a PF may start in the PF or after the PF. |
| NOTE 2: | The PDCCH monitoring occasions for a PO can span multiple radio frames. |

When SearchSpaceId other than 0 is configured for paging-SearchSpace the
PDCCH monitoring occasions for a PO can span multiple periods of the paging
search space.

The following parameters are used for the calculation of PF and i_s above:

| T: | DRX cycle of the UE. |
|---|---|
| If eDRX is not configured as defined in 3GPP standard specification: | |
| - | T is determined by the shortest of the UE specific DRX value(s), if configured by |
| | RRC and/or upper layers or provided in PC5-RRC signalling in case of a L2 U2N |
| | Relay UE, and a default DRX value broadcast in system information. In RRC_IDLE |
| | state, if UE specific DRX is not configured by upper layers, the default value is |
| | applied. |
| In RRC_IDLE state, if eDRX is configured by upper layers, i.e., T_{eDRX, CN}, according to | |
| | 3GPP standard specification: |
| - | If T_{eDRX, CN} is no longer than 1024 radio frames: |

| | |
|---|---|
| - | T = T_{eDRX, CN}; |

| | |
|---|---|
| - | else: |

| | |
|---|---|
| - | During CN configured PTW, T is determined by the shortest of UE specific DRX |

value, if configured by upper layers, and the default DRX value broadcast in
system information.

| In RRC_INACTIVE state, if eDRX is configured by RRC, i.e., T_{eDRX, RAN} , and/or upper | |
|---|---|
| | layers, i.e., T_{eDRX, CN}, as defined in 3GPP standard specification: |
| - | If both T_{eDRX, CN} and T_{eDRX, RAN} are no longer than 1024 radio frames, T = min |
| | {T_{eDRX, RAN}, T_{eDRX, CN}}. |
| - | If T_{eDRX, CN} is no longer than 1024 radio frames and no T_{eDRX, RAN} is configured, T is |
| | determined by the shortest of UE specific DRX value configured by RRC and |
| | _{TeDRX, CN}. |
| - | If T_{eDRX, CN} is longer than 1024 radio frames: |

| | |
|---|---|
| - | If T_{eDRX, RAN} is not configured: |

| | |
|---|---|
| - | During CN configured PTW, T is determined by the shortest of the UE specific |

DRX value (s), if configured by RRC and/or upper layers, and a default DRX
value broadcast in system information. Outside the CN configured PTW, T is
determined by the UE specific DRX value configured by RRC;

| | |
|---|---|
| - | else if T_{eDRX, RAN} is no longer than 1024 radio frames: |

| | |
|---|---|
| - | During CN configured PTW, T is determined by the shortest of the UE specific |

DRX value, if configured by upper layers and T_{eDRX, RAN}, and a default DRX
value broadcast in system information. Outside the CN configured PTW, T is
determined by T_{eDRX, RAN}.

N: number of total paging frames in T
Ns: number of paging occasions for a PF
PF_offset: offset used for PF determination
UE_ID:
If the UE operates in eDRX as specified in 3GPP standard specification:

| | |
|---|---|
| - | 5G-S-TMSI mod 4096 |

else:

| | |
|---|---|
| - | 5G-S-TMSI mod 1024 |

Parameters Ns, nAndPagingFrameOffset, nrofPDCCH-MonitoringOccasionPerSSB-InPO, and
the length of default DRX Cycle are signaled in SIB1. The values of N and PF_offset are
derived from the parameter nAndPagingFrameOffset as defined in 3GPP standard
specification. The parameter firstPDCCH-MonitoringOccasionOfPO is signalled in SIB1 for
paging in the BWP configured by initialDownlinkBWP. For paging in a DL BWP other than
the BWP configured by initialDownlinkBWP, the parameter first-PDCCH-
MonitoringOccasionOfPO is signaled in the corresponding BWP configuration.
If the UE has no 5G-S-TMSI, for instance when the UE has not yet registered onto the
network, the UE shall use as default identity UE_ID = 0 in the PF and i_s formulas above.
5G-S-TMSI is a 48 bit long bit string. 5G-S-TMSI shall in the formulae above be interpreted
as a binary number where the left most bit represents the most significant bit.
In RRC_INACTIVE state, if the UE supports inactiveStatePO-Determination and the network
broadcasts ranPagingInIdlePO with value “true”, the UE shall use the same i_s as for
RRC_IDLE state. Otherwise, the UE determines the i_s based on the parameters and formula
above.
In RRC_INACTIVE state, if eDRX value configured by upper layers is no longer than 1024
radio frames, the UE shall use the same i_s as for RRC_IDLE state.
In RRC_INACTIVE state, if eDRX value configured by upper layers is longer than 1024 radio
frames, during CN PTW, the UE shall use the same i_s as for RRC_IDLE state.

TABLE 2
A paging reception for RRC idle/inactive mode/state

Paging Early Indication
Paging Early Indication reception
The UE may use Paging Early Indication (PEI) in RRC_IDLE and RRC_INACTIVE states in
order to reduce power consumption. If PEI configuration is provided in system information,
the UE in RRC_IDLE or RRC_INACTIVE state supporting PEI (except for the UEs expecting
multicast session activation notification) can monitor PEI using PEI parameters in system
information according to the procedure described below.
If lastUsedCellOnly is configured in system information of a cell, the UE monitors PEI in the
cell only if the UE most recently received RRCRelease without noLastCellUpdate in this cell.
Otherwise (i.e., if lastUsedCellOnly is not configured in system information of a cell), the UE
monitors PEI in the camped cell.
The UE monitors one PEI occasion per DRX cycle. A PEI occasion (PEI-O) is a set of
PDCCH monitoring occasions (MOs) and can consist of multiple time slots (e.g. subframes or
OFDM symbols) where PEI can be sent. In multi-beam operations, the UE assumes that the
same PEI is repeated in all transmitted beams and thus the selection of the beam(s) for the
reception of the PEI is up to UE implementation.
The time location of PEI-O for UE's PO is determined by a reference point and an offset:

| | |
|---|---|
| - | The reference point is the start of a reference frame determined by a frame-level offset |
| | from the start of the first PF of the PF(s) associated with the PEI-O, provided by pei- |
| | FrameOffset in SIB1; |
| - | The offset is a symbol-level offset from the reference point to the start of the first |
| | PDCCH MO of this PEI-O, provided by firstPDCCH-MonitoringOccasionOfPEI-O in |
| | SIB1. |

If one PEI-O is associated with POs of two PFs, the two PFs are consecutive PFs calculated by
the parameters PF_offset, T, Ns, and N. The first PF of the PFs associated with the PEI-O is
provided by (SFN for PF) - floor (i_{PO}/Ns)*T/N, where SFN for PF is determined in 3GPP
standard specification, i_{PO} is defined in [3], T, Ns, and N are determined in 3GPP standard
specification.
The PDCCH MOs for PEI are determined as specified in [3] according to pei-SearchSpace,
pei-FrameOffset, firstPDCCH-MonitoringOccasionOfPEI-O and nrofPDCCH-
MonitoringOccasionPerSSB-InPO if configured as specified in [6]. When SearchSpaceId = 0
is configured for pei-SearchSpace, the PDCCH MOs for PEI are same as for RMSI as defined
in [3]. UE determines first PDCCH MO for PEI-O based on pei-FrameOffset and
firstPDCCH-MonitoringOccasionOfPEI-O, as for the case with SearchSpaceId > 0
configured.
When SearchSpaceId = 0 is configured for pei-SearchSpace, the UE monitors the PEI-O
according to searchSpaceZero. When SearchSpaceId other than 0 is configured for pei-
SearchSpace, the UE monitors the PEI-O according to the search space of the configured
SearchSpaceId.
A PEI occasion is a set of ‘S*X’ consecutive PDCCH monitoring occasions, where ‘S’ is the
number of actual transmitted SSBs determined according to ssb-PositionsInBurst in SIB1, and
X is the nrofPDCCH-MonitoringOccasionPerSSB-InPO if configured or is equal to 1
otherwise. The [x*S+K]^{th} PDCCH MO for PEI in the PEI occasion corresponds to the K^{th}
transmitted SSB, where x=0,1,...,X−1, K=1,2,...,S. The PDCCH MOs for PEI which do not
overlap with UL symbols (determined according to tdd-UL-DL-ConfigurationCommon) are
sequentially numbered from zero starting from the first PDCCH MO for PEI in the PEI-O.
When the UE detects a PEI within its PEI-O, the UE is not required to monitor the subsequent
monitoring occasion(s) associated with the same PEI-O.
If the UE detects PEI and the PEI indicates the subgroup the UE belongs to monitor its
associated PO, as specified in 3GPP standard specification, the UE monitors the associated PO
as specified in 3GPP standard specification. If the UE does not detect PEI on the monitored
PEI occasion or the PEI does not indicate the subgroup the UE belongs to monitor its
associated PO, as specified in 3GPP standard specification, the UE is not required to monitor
the associated PO as specified in 3GPP standard specification.
If the UE is unable to monitor the PEI occasion (i.e. all valid PDCCH MO for PEI)
corresponding to its PO, e.g. during cell re-selection, the UE monitors the associated PO
according to 3GPP standard specification.
In RRC_INACTIVE state, if the UE supports inactiveStatePO-Determination and the network
broadcasts ranPagingInIdlePO with value “true”, the UE shall use the same i_{PO} as for
RRC_IDLE state. Otherwise, the UE determines the i_{PO} based on the formula defined in 3GPP
standard specification.

TABLE 3
A paging reception for RRC idle/inactive mode/state

Subgrouping
General
If PEI and subgrouping are configured, UEs monitoring the same PO can be divided into one
or more subgroups. With subgrouping, the UE monitors the associated PO if the corresponding
bit for subgroup the UE belongs to is indicated as 1 by PEI corresponding to its PO, as
specified in 3GPP standard specification.
The following parameters are used for the determination of subgroup ID:

| | |
|---|---|
| - | subgroupsNumPerPO: total number of subgroups for both CN assigned subgrouping (if |
| | any) and UE_ID based subgrouping (if any) in a PO, which is broadcasted in system |
| | information; |
| - | subgroupsNumForUEID: number of subgroups for UE_ID based subgrouping in a PO, |
| | which is broadcasted in system information. |

UE's subgroup can be either assigned by CN as specified in 3GPP standard specification or
formed based on UE_ID as specified in 3GPP standard specification:

| - | If subgroupsNumForUEID is absent in subgroupConfig, the subgroup ID based on CN | |
|---|---|---|
| | assigned subgrouping as specified in 3GPP standard specification, if available for the | |
| | UE, is used in the cell. | |
| - | If both subgroupsNumPerPO and subgroupsNumForUEID are configured, and | |
| | subgroupsNumForUEID has the same value as subgroupsNumPerPO, the subgroup ID | |
| | based on UE_ID based subgrouping as specified in 3GPP standard specification is used | |
| | in the cell. | |
| - | If both subgroupsNumPerPO and subgroupsNumForUEID are configured, and | |
| | subgroupsNumForUEID < subgroupsNumPerPO: | |
| | - | The subgroup ID based on CN assigned subgrouping as specified in 3GPP standard |
| | | specification, if available for the UE, is used in the cell; |
| | - | Otherwise, the subgroup ID based on UE_ID based subgrouping as specified in 3GPP |

standard specification is used in the cell.

If a UE has no CN assigned subgroup ID or does not support CN assigned subgrouping, and
there is no configuration for subgroupsNumForUEID, the UE monitors the associated PO
according to 3GPP standard specification.
CN assigned subgrouping
Paging with CN assigned subgrouping is used in the cell which supports CN assigned
subgrouping, as described in 3GPP standard specification. A UE supporting CN assigned
subgrouping in RRC_IDLE or RRC_INACTIVE state can be assigned a subgroup ID
(between 0 to 7) by AMF through NAS signalling. The UE belonging to the assigned subgroup
ID monitors its associated PEI which indicates the paged subgroup(s) as specified in 3GPP
standard specification.
UE_ID based subgrouping
Paging with UE_ID based subgrouping is used in the cell which supports UE_ID based
subgrouping, as described in 3GPP standard specification.
If the UE is not configured with a CN assigned subgroup ID, or if the UE configured with a
CN assigned subgroup ID is in a cell supporting only UE_ID based subgrouping, the subgroup
ID of the UE is determined by the formula below:
SubgroupID = (floor(UE_ID/(N*Ns)) mod subgroupsNumForUEID) +

(subgroupsNumPerPO − subgroupsNumForUEID),

where:

| | |
|---|---|
| N: | number of total paging frames in T, which is the DRX cycle of RRC_IDLE state as |
| | specified in 3GPP standard specification |
| Ns: | number of paging occasions for a PF |

```
  UE_ID: 5G-S-TMSI mod X, where X is 32768, if eDRX is applied; otherwise, X is 8192
  subgroupsNumForUEID: number of subgroups for UE_ID based subgrouping in a PO,
```

which is broadcasted in system information

The UE belonging to the SubgroupID monitors its associated PEI which indicates the paged
subgroup(s) as specified in 3GPP standard specification.

TABLE 4
A paging reception for RRC idle/inactive mode/state

```
Paging in extended DRX
The UE may be configured by upper layers and/or RRC with an extended DRX (eDRX) cycle
T_{eDRX, CN} and/or T_{eDRX, RAN}. The UE operates in eDRX for CN paging in RRC_IDLE or
RRC INACTIVE states if the UE is configured for eDRX by upper layers and eDRX-
AllowedIdle is signalled in SIB1. The UE operates in eDRX for RAN paging in
RRC_INACTIVE state if the UE is configured for eDRX by RAN and eDRX-AllowedInactive
is signalled in SIB1. If the UE is configured with an extended DRX cycle no longer than 1024
radio frames, it monitors POs as defined in 3GPP standard specification with configured
eDRX cycle. Otherwise, a UE configured with eDRX monitors POs as defined in 3GPP
standard specification during a periodic Paging Time Window (PTW) configured for the UE.
The PTW is UE-specific and is determined by a Paging Hyperframe (PH), a starting position
within the PH (PTW_start) and an ending position (PTW_end). PH, PTW_start and PTW_end
are given by the following formula:
  The PH for CN is the H-SFN satisfying the following equations:
    H-SFN mod T_{eDRX}_{_{—}}_{CN}= (UE_ID_H mod T_{eDRX}_{_{—}}_{CN}), where
```

| | |
|---|---|
| - | UE_ID_H: 13 most significant bits of the Hashed ID. |
| - | T_{eDRX}_{_{—}}_{CN}: UE-specific eDRX cycle in Hyper-frames, (T_{eDRX}_{_{—}}_{CN} = 2, ..., 1024 Hyper- |
| | frames) configured by upper layers. |

```
  PTW_start denotes the first radio frame of the PH that is part of the PTW and has SFN
  satisfying the following equation:
    SFN = 128 * i_{eDRX}_{_{—}}_{CN}, where
```

| | |
|---|---|
| - | i_{eDRX}_{_{—}}_{CN} = floor(UE_ID_H /T_{eDRX}_{_{—}}_{CN}) mod 8 |

```
  PTW_end is the last radio frame of the PTW and has SFN satisfying the following
    equation:
    SFN = (PTW_start + L*100 − 1) mod 1024, where
```

| | |
|---|---|
| - | L = Paging Time Window (PTW) length (in seconds) configured by upper layers |

```
  Hashed ID is defined as follows:
    Hashed_ID is Frame Check Sequence (FCS) for the bits b31, b30..., b0 of 5G-S-TMSI.
    5G-S-TMSI = <b47, b46, ..., b0> as defined in 3GPP standard specification.
    The 32-bit FCS shall be the ones complement of the sum (modulo 2) of Y1 and Y2,
```

| where | |
|---|---|
| - | Y1 is the remainder of x^{k} (x³¹ + x³⁰ + x²⁹ + x²⁸ + x²⁷ + x²⁶ + x²⁵ + x²⁴ + x²³ + x²² + |
| | x²¹ + x²⁰ + x¹⁹ + x¹⁸ + x¹⁷ + x¹⁶ + x¹⁵ + x¹⁴ + x¹³ + x¹² + x¹¹ + x¹⁰ + x⁹ + x⁸ + x⁷ + x⁶ |
| | + x⁵ + x⁴ + x³ + x² + x¹ + 1) divided (modulo 2) by the generator polynomial x³² + |
| | x²⁶ + x²³ + x²² + x¹⁶ + x¹² + x¹¹ + x¹⁰ + x⁸ + x⁷ + x⁵ + x⁴ + x² + x + 1, where k is 32; |
| | and |
| - | Y2 is the remainder of Y3 divided (modulo 2) by the generator polynomial x³² + |

x²⁶ + x²³ + x²² + x¹⁶ + x¹² + x¹¹ + x¹⁰ + x⁸ + x⁷ + x⁵ + x⁴ + x² + x + 1, where Y3 is
the product of x32 by “b31, b30 ... , b0 of S-TMSI or 5G-S-TMSI”, i.e., Y3 is the
generator polynomial x³² (b31*x³¹ + b30*x³⁰ + ... + b0*1).

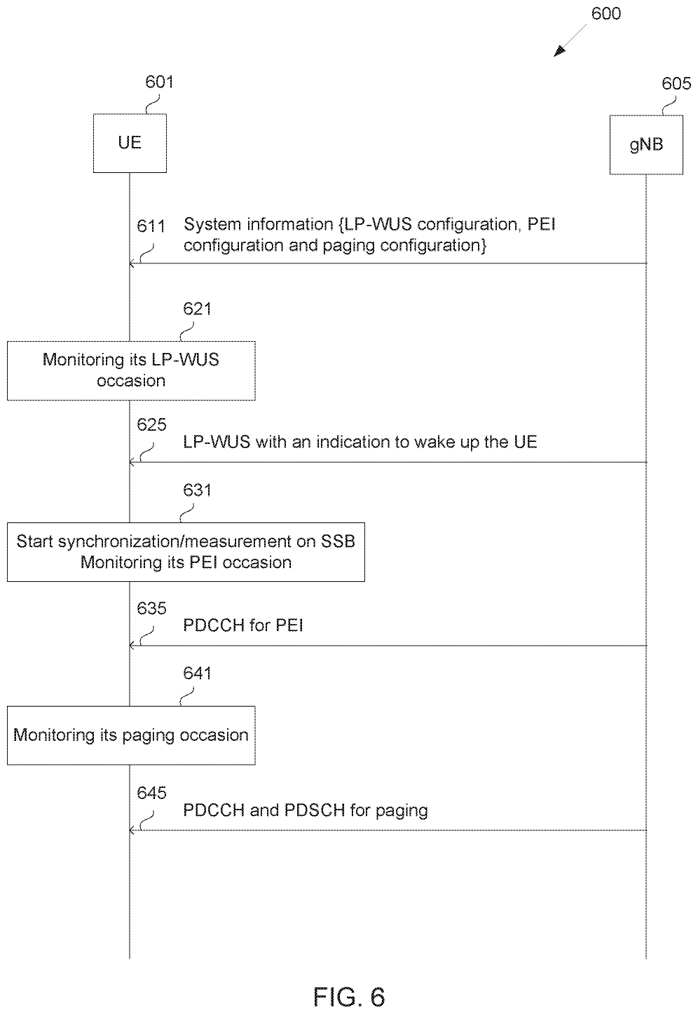

FIG. 6 illustrates another flowchart of a method 600 for a paging reception with LP-WUS according to embodiments of the present disclosure. The method 600 as may be performed by a UE (e.g., 111-116 as illustrated in FIG. 1) and a base station (e.g., 101-103 as illustrated in FIG. 1). An embodiment of the method 800 shown in FIG. 6 is for illustration only. One or more of the components illustrated in FIG. 6 can be implemented in specialized circuitry configured to perform the noted functions or one or more of the components can be implemented by one or more processors executing instructions to perform the noted functions.

FIG. 6 illustrates one example of embodiments for the paging reception with LP-WUS. 601 indicates an RRC idle/inactive mode/state UE that also supports LP-WUS in addition to the existing PEI and paging and 605 indicates a gNB that controls 601 UE's serving cell. Note that it can be also applicable to RRC connected mode/state UEs. 611 indicates LP-WUS configuration (e.g., LP-WUS resource in frequency and time domain, LP-WUS sequence code related information, etc.), PEI configuration (PEI occasion configuration, subgrouping configuration, etc.) and paging configuration (paging occasion configuration, etc.) are configured via system information.

Once the UE receives 611 system information, the UE only monitors its LP-WUS occasion (621). LP-WUS occasion can be defined as the closest LP-WUS resource in time domain before its PEI occasion. The closest LP-WUS resource can be defined by either implicit way (e.g. the UE selects the closest LP-WUS resource, among all candidate/configured LP-WUS resources, before its PEI occasion) or explicit way (e.g. a kind of equation to select the closest LP-WUS resource before its PEI occasion is defined, for example by using threshold#1, offset#1, UE id, and/or any other relation to its PEI occasion, etc.). Alternatively, LP-WUS occasion can be defined as the closest LP-WUS resource that at least separated by threshold#1/offset#1 before its PEI occasion. The threshold#1/offset#1 can be also configured in 611. If the UE receives LP-WUS with an indication to wake up the UE in the LP-WUS occasion (625), the UE starts synchronization and/or measurement based on SSB before its PEI occasion and monitors PDCCH for PEI reception in its PEI occasion (631). Note the indication can be signaled either implicitly (e.g. detection of LP-WUS itself, or any other means) or explicitly (e.g. detected LP-WUS contains explicit indication/instruction to wake up the UE, or any other means).

Otherwise (if the UE does not receive LP-WUS to wake up the UE in the LP-WUS occasion), the UE skips the procedures in 631 and 641, and sleeps until the next incoming LP-WUS occasion to monitor. If the UE receives PEI in the PEI occasion (635), the UE monitors PDCCH and PDSCH for paging reception in its paging occasion (641). Then the UE receives paging in the paging occasion (645). Note if the UE only supports LP-WUS reception without supporting PEI reception, or if the UE supports both LP-WUS and PEI receptions but PEI is not configured in the system information, UE skips any PEI reception behavior, i.e. UE first monitors LP-WUS and then directly monitors the paging occasion if LP-WUS is detected in the LP-WUS occasion or the detected LP-WUS includes a wake-up indication/instruction for the UE.

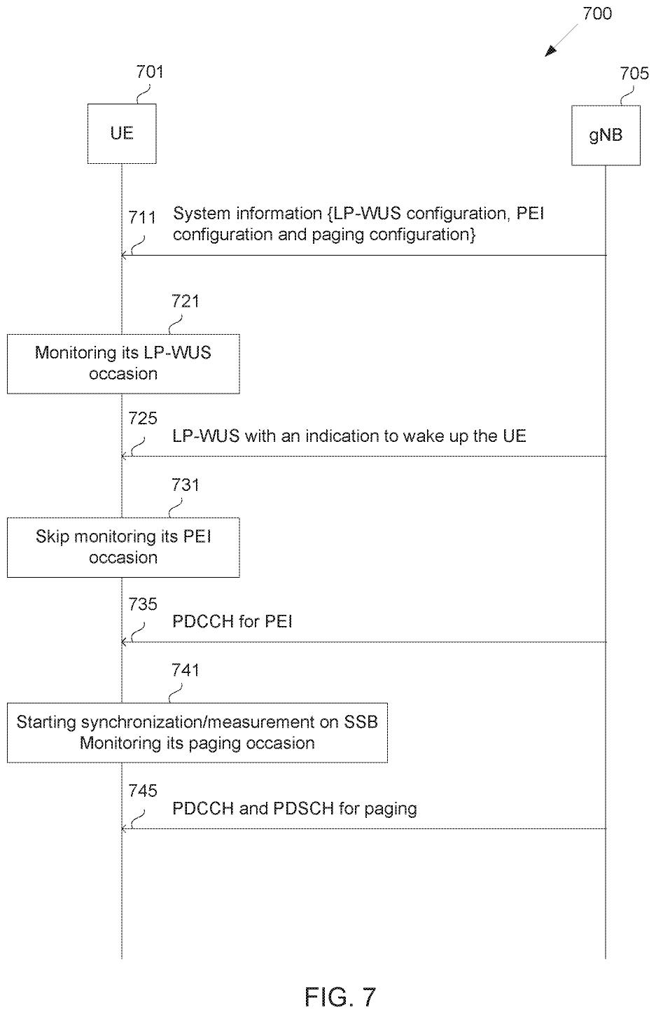

FIG. 7 illustrates another flowchart of a method 700 for a paging reception with LP-WUS according to embodiments of the present disclosure. The method 700 as may be performed by a UE (e.g., 111-116 as illustrated in FIG. 1) and a base station (e.g., 101-103 as illustrated in FIG. 1). An embodiment of the method 800 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

FIG. 7 illustrates another example of embodiments for the paging reception with LP-WUS. 701 indicates an RRC idle/inactive mode/state UE that also supports LP-WUS in addition to the existing PEI and paging and 705 indicates a gNB that controls 701 UE's serving cell. Note that it can be also applicable to RRC connected mode/state UEs. Also note the UE can only supports LP-WUS reception without supporting PEI reception. 711 indicates LP-WUS configuration (e.g., LP-WUS resource in frequency and time domain, LP-WUS sequence code related information, etc.), a PEI configuration (PEI occasion configuration, subgrouping configuration, etc.) and a paging configuration (paging occasion configuration, etc.) are configured via system information.

Once the UE receives 711 system information, the UE only monitors its LP-WUS occasion (721). LP-WUS occasion can be defined as the closest LP-WUS resource in time domain before its paging occasion. The closest LP-WUS resource can be defined by either implicit way (e.g. the UE selects the closest LP-WUS resource, among all candidate/configured LP-WUS resources, before its paging occasion) or explicit way (e.g. a kind of equation to select the closest LP-WUS resource before its paging occasion is defined, for example by using threshold#2, offset#2, UE id, and/or any other relation to its paging occasion, etc.).

Alternatively, LP-WUS occasion can be defined as the closest LP-WUS resource that at least separated by threshold#2/offset#2 before its paging occasion. The threshold#2/offset#2 can be also configured in 711. If the UE receives LP-WUS with an indication to wake up the UE in the LP-WUS occasion (725), the UE skips monitoring PDCCH for PEI reception (731) so 535 PEI is not received/decoded. Note the indication can be signaled either implicitly (e.g. detection of LP-WUS itself, or any other means) or explicitly (e.g. detected LP-WUS contains explicit indication/instruction to wake up the UE, or any other means). Instead, the UE starts synchronization and/or measurement on SSB before its paging occasion and directly monitors PDCCH and PDSCH for paging reception in its paging occasion (741) so 745 paging is received. Note synchronization and/or measurement on SSB can be started once the UE receives LP-WUS to wake up the UE. If the UE does not receive LP-WUS with the indication to wake up the UE in the LP-WUS occasion, the UE skips the procedure in 731 and 741, and sleeps until the next incoming LP-WUS occasion to monitor.

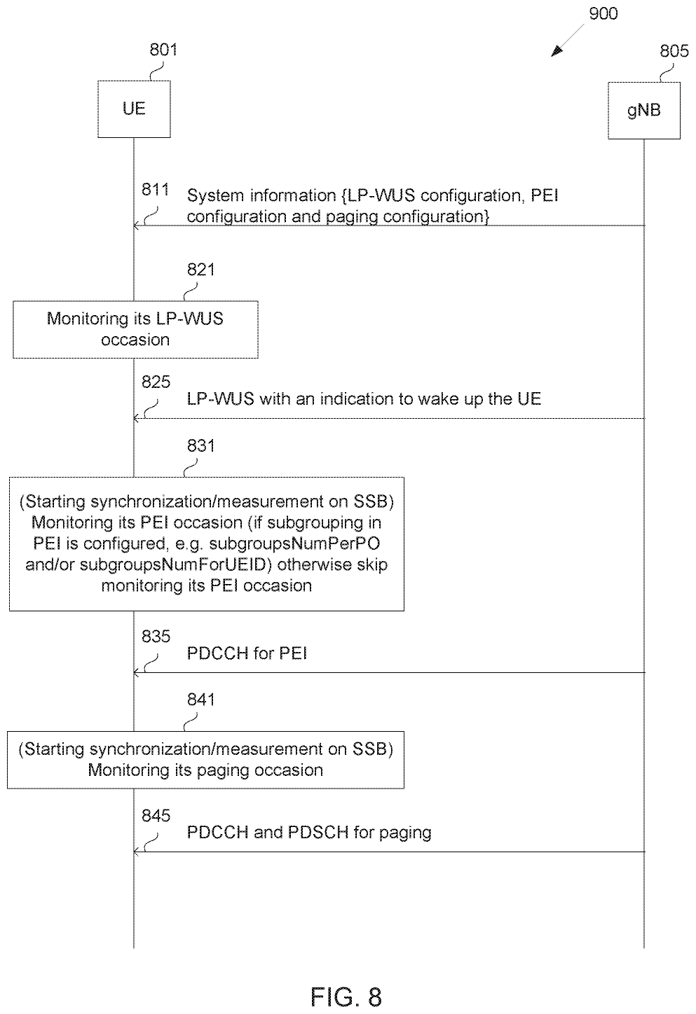

FIG. 8 illustrates yet another flowchart of a method 800 for a paging reception with LP-WUS according to embodiments of the present disclosure. The method 800 as may be performed by a UE (e.g., 111-116 as illustrated in FIG. 1) and a base station (e.g., 101-103 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

FIG. 8 illustrates another example of embodiments for the paging reception with LP-WUS. 801 indicates an RRC idle/inactive mode/state UE that also supports LP-WUS in addition to the existing PEI and paging and 805 indicates a gNB that controls 801 UE's serving cell. Note that it can be also applicable to RRC connected mode/state UEs. 811 indicates LP-WUS configuration (e.g., LP-WUS resource in frequency and time domain, LP-WUS sequence code related information, etc.), a PEI configuration (PEI occasion configuration, subgrouping configuration, etc.) and a paging configuration (paging occasion configuration, etc.) are configured via system information. Once the UE receives 811 system information, the UE only monitors its LP-WUS occasion (821).

LP-WUS occasion can be defined as the closest LP-WUS resource in time domain before its PEI occasion. The closest LP-WUS resource can be defined by either implicit way (e.g. the UE selects the closest LP-WUS resource, among all candidate/configured LP-WUS resources, before its PEI occasion) or explicit way (e.g. a kind of equation to select the closest LP-WUS resource before its PEI occasion is defined, for example by using threshold#1, offset#1, UE id, and/or any other relation to its PEI occasion, etc.). Alternatively, LP-WUS occasion can be defined as the closest LP-WUS resource that at least separated by threshold#1/offset#1 before its PEI occasion. The threshold#1/offset#1 can be also configured in 811.

Alternately, the UE checks if subgrouping is configured/included in a PEI configuration (e.g., whether subgroupsNumPerPO and/or subgroupsNumForUEID is/are configured/included in a PEI configuration in 811). If a subgrouping is configured in 811, LP-WUS occasion can be defined as the closest LP-WUS resource in time domain before its PEI occasion, as described above. If a subgrouping is not configured in 811, LP-WUS occasion can be defined as the closest LP-WUS resource in time domain before its paging occasion, as described in the FIG. 7.

If the UE receives LP-WUS with an indication to wake up the UE in the LP-WUS occasion (825) and if the subgrouping is configured/included in the PEI configuration, the UE starts synchronization and/or measurement based on SSB before its PEI occasion and monitors PDCCH for PEI reception in its PEI occasion (831). Note that the indication can be signaled either implicitly (e.g., detection of LP-WUS itself, or any other means) or explicitly (e.g., detected LP-WUS contains explicit indication/instruction to wake up the UE, or any other means). If the UE receives PEI in the PEI occasion (835) and the PEI indicates the subgroup the UE belongs to monitor its associated PO, the UE monitors PDCCH and PDSCH for paging reception in its paging occasion (841) so 845 paging is received. If the UE does not receive PEI in the PEI occasion or the received PEI does not indicate the subgroup the UE belongs to monitor its associated PO, the UE skips monitoring of PDCCH and PDSCH for paging reception in the paging occasion.

If the UE receives LP-WUS with the indication to wake up the UE in the LP-WUS occasion (825) but if the subgrouping is not configured/included in the PEI configuration, the UE skips monitoring PDCCH for PEI reception (831) so 835 PEI is not received/decoded. Instead, the UE starts synchronization and/or measurement on SSB before its paging occasion and directly monitors PDCCH and PDSCH for paging reception in its paging occasion (841) so 845 paging is received. Note synchronization and/or measurement on SSB can be started once the UE receives LP-WUS to wake up the UE. If the UE does not receive LP-WUS with the indication to wake up the UE in the LP-WUS occasion, the UE skips any monitoring of PDCCH and/or PDSCH for PEI and paging reception, and sleeps until the next incoming LP-WUS occasion to monitor. Note if the UE only supports LP-WUS reception without supporting PEI reception, or if the UE supports both LP-WUS and PEI receptions but PEI is not configured in the system information, UE skips any PEI reception behavior, i.e. UE first monitors LP-WUS and then directly monitors the paging occasion if LP-WUS is detected in the LP-WUS occasion or the detected LP-WUS includes a wake-up indication/instruction for the UE.

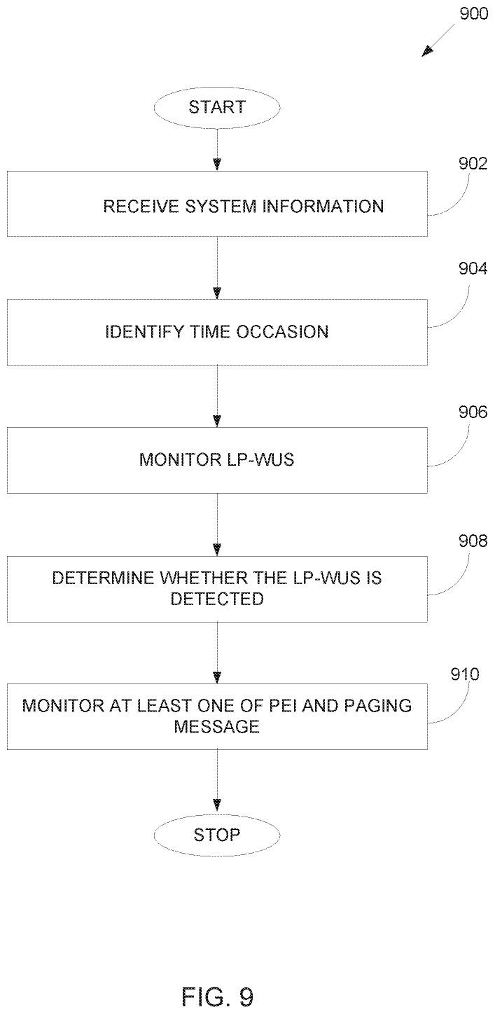

FIG. 9 illustrates a flowchart of a UE method 900 for paging reception with low power signals according to embodiments of the present disclosure. The method 900 as may be performed by a UE (e.g., 111-116 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, the method 900 begins at step 902. In step 902, a UE receives, from a BS, SI.

In such embodiment, the SI includes at least one of a threshold and an offset.

In step 904, the UE identifies, based on the SI, time occasions to monitor a LP-WUS from a plurality of LP-WUSs.

In step 906, the UE monitor, based on the time occasions, the LP-WUS associated with a serving cell.

In step 908, the UE determines whether the LP-WUS is detected in the time occasions.

In step 910, the UE monitors, based on the determination that the LP-WUS is detected, at least one of a PEI and a paging message.

In one embodiment, the UE determines whether the LP-WUS includes an indication for the UE to wake up.

In one embodiment, the UE determines whether to monitor the PEI, identifies the time occasions before monitoring the PEI when the UE is configured to monitor the PEI; or identifies the time occasions before monitoring the paging message when the UE is not configured to monitor the PEI.

In one embodiment, the UE receives, from the BS, a SSB and activates, based on the SSB, a synchronization and measurement operation, wherein the synchronization and measurement operation is activated after LP-WUS is detected in the time occasions.

In one embodiment, the UE determines whether the SI including PEI configuration information is received; based on a determination that the SI including the PEI configuration information is received and the UE is capable of supporting a PEI reception, starting monitoring the PEI; and based on a determination that the SI including the PEI configuration information is not received or the UE is not capable of supporting the PEI reception, starting monitoring the paging message.

In one embodiment, the UE determines whether the SI including PEI configuration information comprises sub-grouping information, when the PEI configuration information includes sub-grouping information and the UE is capable of supporting a PEI reception, starting monitoring the PEI, and when the PEI configuration information does not include sub-grouping information or the UE is not capable of supporting the PEI reception, starting monitoring the paging message.

In one embodiment, the UE identifies the sub-grouping information based on at least one of a subgroup number per paging occasion (subgroupsNumberPerPO) and a subgroup number for UE identification (subgroupsNumberForUEID).

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive, from a base station (BS), system information (SI); and
a processor operably coupled to the transceiver, the processor configured to:
identify, based on the SI, time occasions to monitor a low power-wake-up signal (LP-WUS) from a plurality of LP-WUSs,
monitor, based on the time occasions, the LP-WUS associated with a serving cell,
determine whether the LP-WUS is detected in the time occasions, and
monitor, based on the determination that the LP-WUS is detected, at least one of a paging early indicator (PEI) and a paging message.

2. The UE of claim 1, wherein the processor is further configured to determine whether the LP-WUS includes an indication for the UE to wake up.

3. The UE of claim 1, wherein the SI includes at least one of a threshold and an offset.

4. The UE of claim 1, wherein the processor is further configured to:
determine whether to monitor the PEI;
identify the time occasions before monitoring the PEI when the UE is configured to monitor the PEI; or
identify the time occasions before monitoring the paging message when the UE is not configured to monitor the PEI.

5. The UE of claim 1, wherein:
the transceiver is further configured to receive, from the BS, a synchronization signal/physical broadcasting channel block (SSB);
the processor is further configured to activate, a synchronization and measurement operation, based on the SSB; and
the synchronization and measurement operation is activated after LP-WUS is detected in the time occasions.

6. The UE of claim 1, wherein the processor is further configured to:
determine whether the SI including PEI configuration information is received
based on a determination that the SI including the PEI configuration information is received and the UE is capable of supporting a PEI reception, start monitoring the PEI; and
based on a determination that the SI including the PEI configuration information is not received or the UE is not capable of supporting the PEI reception, start monitoring the paging message.

7. The UE of claim 1, wherein the processor is further configured to:
determine whether the SI including PEI configuration information comprises sub-grouping information;
based on a determination that the PEI configuration information includes sub-grouping information and the UE is capable of supporting a PEI reception, start monitoring the PEI; and
based on a determination that the PEI configuration information does not include the sub-grouping information or the UE is not capable of supporting the PEI reception, start monitoring the paging message.

8. The UE of claim 7, wherein the processor is further configured to identify the sub-grouping information based on at least one of a subgroup number per paging occasion (subgroupsNumberPerPO) and a subgroup number for UE identification (subgroupsNumberForUEID).

9. A method of a user equipment (UE) in a wireless communication system, the method comprising:
receiving, from a base station (BS), system information (SI);
identifying, based on the SI, time occasions to monitor a low power-wake-up signal (LP-WUS) from a plurality of LP-WUSs;
monitoring, based on the time occasions, the LP-WUS associated with a serving cell;
determining whether the LP-WUS is detected in the time occasions; and
monitoring, based on the determination that the LP-WUS is detected, at least one of a paging early indicator (PEI) and a paging message.

10. The method of claim 9, further comprising determining whether the LP-WUS includes an indication for the UE to wake up.

11. The method of claim 9, wherein the SI includes at least one of a threshold and an offset.

12. The method of claim 9, further comprising:
determining whether to monitor the PEI,
identifying the time occasions before monitoring the PEI when the UE is configured to monitor the PEI; or
identifying the time occasions before monitoring the paging message when the UE is not configured to monitor the PEI.

13. The method of claim 9, further comprising:
receiving, from the BS, a synchronization signal/physical broadcasting channel block (SSB); and
activating, based on the SSB, a synchronization and measurement operation,
wherein the synchronization and measurement operation is activated after LP-WUS is detected in the time occasions.

14. The method of claim 9, further comprising:
determining whether the SI including PEI configuration information is received;
based on a determination that the SI including the PEI configuration information is received and the UE is capable of supporting a PEI reception, starting monitoring the PEI; and
based on a determination that the SI including the PEI configuration information is not received or the UE is not capable of supporting the PEI reception, starting monitoring the paging message.

15. The method of claim 9, further comprising:
determining whether the SI including PEI configuration information comprises sub-grouping information;
when the PEI configuration information includes sub-grouping information and the UE is capable of supporting a PEI reception, starting monitoring the PEI; and
when the PEI configuration information does not include sub-grouping information or the UE is not capable of supporting the PEI reception, starting monitoring the paging message.

16. The method of claim 15. further comprising identifying the sub-grouping information based on at least one of a subgroup number per paging occasion (subgroupsNumberPerPO) and a subgroup number for UE identification (subgroupsNumberForUEID).

17. A base station (BS) in a wireless communication system, the BS comprising:
a processor configured to generate system information (SI) including time occasions for a low power-wake-up signal (LP-WUS); and
a transceiver operably coupled to the transceiver, the transceiver configured to transmit, to a user equipment (UE), the SI,
wherein:
the LP-WUS associated with a serving cell is monitored from a plurality of LP-WUSs based on the time occasions, and
at least one of a paging early indicator (PEI) and a paging message is monitored based on a detectability of the LP-WUS.

18. The BS of claim 17, wherein the SI includes at least one of a threshold and an offset.

19. The BS of claim 17, wherein whether to monitor the PEI is determined, and wherein:
the time occasions are identified before the PEI is monitored when the UE is configured to monitor the PEI; or
the time occasions are identified before the paging message is monitored when the UE is not configured to monitor the PEI.

20. The BS of claim 17, wherein the transceiver is further configured to transmit, to the UE, a synchronization signal/physical broadcasting channel block (SSB), and
wherein:
a synchronization and measurement operation is activated based on the SSB; and
the synchronization and measurement operation is activated after LP-WUS is detected in the time occasions.
